(19) United States
(12) Patent Application Publication
(10) Pub. No.: US 2026/0301774 A1
(43) Pub. Date: Oct. 1, 2026

(54) SYSTEMS, METHODS, APPARATUSES, AND COMPUTER PROGRAM PRODUCTS FOR PROVIDING MEDIA CONTENT BASED ON CONTEXT

(71) Applicant: Nokia Technologies Oy, Espoo (FI)

(72) Inventors: Kashyap KAMMACHI SREEDHAR, Tampere (FI); Emre Baris AKSU, Tampere (FI); Miska Matias HANNUKSELA, Tampere (FI); Lukasz KONDRAD, Munich (DE)

(21) Appl. No.: 19/573,673

(22) Filed: Mar. 20, 2026

Related U.S. Application Data
(60) Provisional application No. 63/778,081, filed on Mar. 26, 2025.

(51) Int. Cl. G11B 27/34

(52) U.S. Cl. CPC G11B 27/34

(57) ABSTRACT

Systems, methods, apparatuses, and computer program products for providing media content based on context are provided. Some examples include generating a first file that comprises a first content item and one or more first context identifiers. Some examples include generating a second file that comprises a second content item and one or more second context identifiers. In some examples, a corresponding context identifier between the one or more first context identifiers and the one or more second context identifiers indicates a particular context associated with capture of the first content item and the second content item.

### CROSS REFERENCE TO RELATED APPLICATIONS

This application claims priority to U.S. Appl. No. 63/778,081 filed Mar. 26, 2025, the contents of which are incorporated herein in its entirety by reference.

### TECHNOLOGICAL FIELD

An example embodiment relates generally to video coding and decoding and, more particularly, but not exclusively, to providing media content based on context.

### BACKGROUND

A video coding system may include an encoder that transforms (e.g., encodes) a video sequence into a compressed representation suited for storage and/or transmission. For example, the encoder may discard certain information in the video sequence in order to represent the video sequence in a more compact form (e.g., a lower bitrate, etc.) for storage and/or transmission of the video sequence. Additionally, a video coding system may include a decoder that uncompress (e.g., decodes) the compressed representation of the video sequence to enable consumption of the video sequence in a viewable form via a display. However, content of a video sequence may be captured via different devices and/or at different locations. Moreover, content of a video sequence may be processed by different video coding systems (e.g., different encoders).

### BRIEF SUMMARY

According to some aspects, there is provided the subject matter of the independent claims. Some further aspects are defined in the dependent claims.

### BRIEF DESCRIPTION OF THE DRAWINGS

A better understanding of the subject disclosure may be obtained when the following detailed description of various embodiments is considered in conjunction with the following drawings, in which:

FIG. 1 shows a block flow diagram illustrating a process for video encoding and decoding, in accordance with one or more embodiments of the present disclosure;

FIG. 2 shows schematically an example of a system for video encoding and decoding, in accordance with one or more embodiments of the present disclosure;

FIG. 3 shows schematically an example of a decoder-side device configured for carrying out video decoding, in accordance with one or more embodiments of the present disclosure;

FIG. 4 shows schematically an example of an encoder-side device configured for carrying out video encoding, in accordance with one or more embodiments of the present disclosure;

FIG. 5 shows an example file, in accordance with one or more embodiments of the present disclosure;

FIG. 6 is a flowchart of operations according to certain example embodiments implemented, for example, by an apparatus as described herein; and

FIG. 7 is a flowchart of operations according to certain example embodiments implemented, for example, by an apparatus as described herein.

### DETAILED DESCRIPTION

The examples and embodiments set forth below represent information to enable those skilled in the art to practice the subject disclosure. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

The following embodiments are examples. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

As used herein, “plurality” means two or more. As used herein, a “set” of items may include one or more of such items. As used herein, whether in the subject disclosure or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims or the subject disclosure to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements. As used herein, “and/or” and “at least one of” means that the listed items are alternatives, but the alternatives also include any combination of the listed items.

Like reference numerals refer to like elements throughout. As used herein, the terms “data,” “content,” “information,” and similar terms may be used interchangeably to refer to data capable of being transmitted, received and/or stored in accordance with an embodiment of the present disclosure. Thus, use of any such terms should not be taken to limit the spirit and scope of one or more embodiments of the present disclosure.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As defined herein, a “computer-readable storage medium,” which refers to a physical storage medium (e.g., volatile or non-volatile memory device), may be differentiated from a “computer-readable transmission medium,” which refers to an electromagnetic signal.

Systems, methods, apparatuses, and computer program products for providing media content based on context are provided in accordance with one or more embodiments of the subject disclosure. The systems, methods, apparatuses, and computer program products may be utilized in conjunction with a variety of video formats including High Efficiency Video Coding standard (HEVC or H.265/HEVC), Advanced Video Coding standard (AVC or H.264/AVC), Versatile Video Coding standard (VVC or H.266/VVC), and/or with a variety of video and multimedia file formats including International Standards Organization (ISO) base media file format (ISO/IEC 14496-12, which may be abbreviated as ISOBMFF), Moving Picture Experts Group (MPEG)-4 file format (ISO/IEC 14496-14, also known as the MP4 format), and file formats for NAL (Network Abstraction Layer) unit structured video (ISO/IEC 14496-15) and 3^{rd} Generation Partnership Project (3GPP file format) (3GPP Technical Specification 26.244, also known as the 3GP format). ISOBMFF is the base for derivation of all the above mentioned file formats.

Some aspects of the disclosure relate to container file formats, such as International Standards Organization (ISO) base media file format (ISO/IEC 14496-12, which may be abbreviated as ISOBMFF), Moving Picture Experts Group (MPEG)-4 file format (ISO/IEC 14496-14, also known as the MP4 format), and file formats for NAL (Network Abstraction Layer) unit structured video (ISO/IEC 14496-15) and 3^{rd} Generation Partnership Project (3GPP file format) (3GPP Technical Specification 26.244, also known as the 3GP format). For example, the ISOBMFF file format may be a defined container file format for media content. Example embodiments are described in conjunction with the ISOBMFF file format or its derivatives, however, the present disclosure is not limited to ISOBMFF, but rather the description is given for one possible basis on top of which an example embodiment of the present disclosure may be partly or fully realized.

The High Efficiency Image File Format (HEIF) is a standard developed by the Moving Picture Experts Group (MPEG) for storage of images and image sequences. HEIF includes a rich set of features building on top of the ISOBMFF standard. For example, the HEIF file format may be a defined container file format for media content. Example embodiments are described in conjunction with the HEIF file format or its derivatives, however, the present disclosure is not limited to HEIF, but rather the description is given for one possible basis on top of which an example embodiment of the present disclosure may be partly or fully realized.

A basic building block in the ISO base media file format is called a box. Each box has a header and a payload. The box header indicates the type of the box and the size of the box in terms of bytes. Box type is typically identified by an unsigned 32-bit integer, interpreted as a four character code (4CC). A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

In files conforming to the ISO base media file format, the media data may be provided in one or more instances of MediaDataBox (‘mdat’) and the MovieBox (‘moov’) may be used to enclose the metadata for timed media. The MovieBox may be a movie presentation identifier box. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they contain an elementary media stream. Other track types comprise hint tracks and timed metadata tracks.

Tracks comprise samples, such as audio or video frames. For video tracks, a media sample may correspond to a coded picture or an access unit. A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. A timed metadata track may refer to samples describing referred media and/or hint samples. The ‘trak’ box includes in its hierarchy of boxes the SampleDescriptionBox, which gives detailed information about the coding type used, and any initialization information needed for that coding. The SampleDescriptionBox contains an entry-count and as many sample entries as the entry-count indicates. The format of sample entries is track-type specific but derived from generic classes (e.g. VisualSampleEntry, AudioSampleEntry). Which type of sample entry form is used for derivation of the track-type specific sample entry format is determined by the media handler of the track. The track reference mechanism can be used to associate tracks with each other. The TrackReferenceBox includes box(es), each of which provides a reference from the containing track to a set of other tracks. These references are labeled through the box type (e.g., the four-character code of the box) of the contained box(es).

In ISOMBFF, an edit list provides a mapping between the presentation timeline and the media timeline. Among other things, an edit list provides for the linear offset of the presentation of samples in a track, provides for the indication of empty times and provides for a particular sample to be dwelled on for a certain period of time. The presentation timeline may be accordingly modified to provide for looping, such as for the looping videos of the various regions of the scene. Files conforming to the ISOBMFF may contain any non-timed objects, referred to as items, meta items, or metadata items, in a Metabox (four-character code: ‘meta’). While the name of the Metabox refers to metadata, items can generally contain metadata or media data. The Metabox may reside at the top level of the file, within a Moviebox (four-character code: ‘moov’), and within a track box (four-character code: ‘trak’), but at most one Metabox may occur at each of the file level, movie level, or track level. The Metabox may be utilized to contain a ‘hdlr’ box indicating the structure or format of the ‘meta’ box contents. The Metabox may list and characterize any number of items that can be referred and each one of them can be associated with a file name and are uniquely identified with the file by item identifier (item_id) which is an integer value. The metadata items may be for example stored in the ‘idat’ box of the Metabox or in an ‘mdat’ box or reside in a separate file. If the metadata is located external to the file then its location may be declared by the DataInformationBox (four-character code: ‘dinf’). In the specific case that the metadata is formatted using eXtensible Markup Language (XML) syntax and may be utilized to be stored directly in the MetaBox, the metadata may be encapsulated into either the XMLBox (four-character code: ‘xml’) or the BinaryXMLBox (four-character code: ‘bxml’). An item may be stored as a contiguous byte range, or it may be stored in several extents, each being a contiguous byte range. In other words, items may be stored fragmented into extents, e.g. to enable interleaving. An extent is a contiguous subset of the bytes of the resource. The resource can be formed by concatenating the extents.

A common base structure is used to contain general untimed metadata. This structure is called the MetaBox as it was originally designed to carry metadata, i.e. data that is annotating other data. However, it is now used for a variety of purposes including the carriage of data that is not annotating other data, especially when present at ‘file level’. The MetaBox may be utilized to contain a HandlerBox indicating the structure or format of the MetaBox contents. Other contained boxes are specific to the format specified by the HandlerBox. The other boxes defined here may be defined as optional or mandatory for a given format. If they are used, then they shall take the form specified here. These optional boxes include a DataInformationBox, which documents other files in which metadata values (e.g. pictures) are placed, and an ItemLocationBox, which documents where in those files each item is located (e.g. in the common case of multiple pictures stored in the same file). A MetaBox may occur at each of the file level, segment, movie level, or track level. If an ItemProtectionBox occurs, then some or all of the metadata, including possibly the primary resource, may have been protected and be un-readable unless the protection system is taken into account

HEIF is a standard developed by the MPEG for storage of images and image sequences. Among other things, the standard facilitates file encapsulation of data coded according to the HEVC standard. HEIF includes features building on top of the used ISOBMFF. The ISOBMFF structures and features are used to a large extent in the design of HEIF. The basic design for HEIF comprises still images that are stored as items and image sequences that are stored as tracks. An item in HEIF is defined as the data that does not require timed processing, as opposed to sample data, and is described by the boxes contained in a MetaBox. In the context of HEIF, the following boxes may be contained within the root-level ‘meta’ box and may be used as described in the following. In HEIF, the handler value of the Handler box of the ‘meta’ box is ‘pict’. The resource (whether within the same file, or in an external file identified by a uniform resource identifier) containing the coded media data is resolved through the Data Information (‘dinf’) box, whereas the Item Location (‘iloc’) box stores the position and sizes of every item within the referenced file. The Item Reference (‘iref’) box documents relationships between items using typed referencing. If there is an item among a collection of items that is in some way to be considered the most important compared to others then this item is signaled by the Primary Item (‘pitm’) box. Apart from the boxes mentioned here, the ‘meta’ box is also flexible to include other boxes that may be necessary to describe items.

Any number of image items can be included in the same file. Given a collection of images stored by using the ‘meta’ box approach, it sometimes is essential to qualify certain relationships between images. Examples of such relationships include indicating a cover image for a collection, providing thumbnail images for some or all of the images in the collection, and associating some or all of the images in a collection with an auxiliary image such as an alpha plane. A cover image among the collection of images is indicated using the ‘pitm’ box. A thumbnail image or an auxiliary image is linked to the primary image item using an item reference of type ‘thmb’ or ‘auxl’, respectively.

HEIF defines the Album Collection entity group (‘albc’) which indicates a set of entities that form an album of images. Human readable description may be associated with an Album Collection entity group using a user-description item property ‘udes’. Human-readable description with alternatives languages can be obtained by associating multiple user-description item properties with different lang attributes. There may be multiple ‘albc’ entity groupings in the same file with different group_id values, and the same image may belong to multiple album collections. The Favorites Collection entity group (‘favc’) indicates a set of entities that form a collection of favorites images. Human readable description may be associated with a Favorites Collection entity group using a user-description item property ‘udes’. Human-readable description with alternatives languages can be obtained by associating multiple user-description item properties with different lang attributes. There may be multiple ‘favc’ entity groupings in the same file with different group_id values, and the same image may belong to multiple favorites collections.

A time-synchronized capture entity group (‘tsyn’) contains entities that were synchronously captured. A single ‘tsyn’ entity group may include entity_id values that either resolve to image items or to image sequence tracks, but not a mixture of both. A ‘tsyn’ entity group including image items indicates that the image items were simultaneously captured spanning the same time. A ‘tsyn’ entity group including image sequence tracks indicates that all tracks in the group, if played using the timing in the file, are in sync. Tracks included in the same ‘tsyn’ entity group have the same duration. There may be multiple ‘tsyn’ entity groupings in the same file with different group_id values.

A uniform resource identifier (URI) may be defined as a string of characters used to identify a name of a resource. Such identification enables interaction with representations of the resource over a network, using specific protocols. A URI is defined through a scheme specifying a concrete syntax and associated protocol for the URI. The uniform resource locator (URL) and the uniform resource name (URN) are forms of URI. A URL may be defined as a URI that identifies a web resource and specifies the means of acting upon or obtaining the representation of the resource, specifying both its primary access mechanism and network location. A URN may be defined as a URI that identifies a resource by name in a particular namespace. A URN may be used for identifying a resource without implying a location of the resource or how to access the resource.

However, current video coding and decoding techniques related to defined container file formats do not utilize information regarding how track files are located, how dependencies across tracks are set, and/or how track groups are setup. For example, a decoder is currently unable to determine how the image items relate to each other for a HEIF file containing multiple image items. A HEIF file may include an entity group for signaling a variety of scenarios (e.g., panoramas, focus stack, etc.), but a HEIF file is currently unable to indicate to a decoder that certain image items were captured during event X and other image items were captured during event Y. In an example, three-dimensional (3D) reconstruction of a physical object may be provided by capturing a number of images from different angles and storing their relative positioning. These images are then run through an algorithm to create a 3D model of the object. In certain instances, these images may be stored in a HEIF file where the images are stored with respective relative positions described by item properties. However, a capturing algorithm associated with an encoder may not know the number of images and/or the encoder may delete captured images if better images are captured later in a capture process.

In another example, an ISOBMFF file may include sample data containing structure data (e.g., ‘trak’ or ‘traf’ box) or an ISOBMFF file may refer to the sample data through a uniform resource locator/uniform resource name (e.g., as indicated in DataReferenceBox). However, an ISOBMFF file is currently unable to refer to complete tracks (e.g., sample data and structure-data) in other ISOBMFF files. Additionally, if a track from a first ISOBMFF file is referenced in a second ISOBMFF file, relying on data reference causes the structure data (e.g., track box hierarchy) to be duplicated, thereby increasing memory utilization and/or computing resources since any change to the referenced file(s) are reflected in the referring file due to file offset changes. A change may be due to media editing, adding a new brand, re-interleaving, fragmenting, etc.

In another example, a ISOBMFF file may specify encapsulation of media streams into tracks of a file such that all tracks of a media presentation are contained in a single file with a single Moviebox that documents all tracks in the file. However, a ISOBMFF file typically cannot be utilized for certain streaming protocols such as a common medial application format (CMAF) streaming protocol or a dynamic adaptive streaming over HTTP (DASH) streamlining protocol since steaming protocols typically utilize late binding (e.g., each track stored in a separate file). Each file typically includes its own movie header and a relationship regarding tracks in different files cannot be expressed. Without the uniqueness established between tracks (e.g., media streams), a file reader may be unable to accurately select tracks for playback, thereby resulting in undesirable video playback behavior via a user device. As such, it is desirable to utilize a new file description box or extend a current file description box for video coding and decoding with supplemental information that can be utilized to process two or more file (e.g., two or more ISOBMFF files, two or more HEIF files, etc.).

As such, described herein are systems, methods, apparatuses, and computer program products for providing media content based on context. For example, media content may be stored and/or delivered based on context associated with capture of the media content. As such, media content may be optimally captured and/or processed by different entities based on context. Additionally or alternatively, media content captured and/or processed by different entities may be optimally consumed and/or categorized together based on context. In some embodiments, the context may be related to a location (e.g., a geographic location or a location of a particular event). In some embodiments, the context may be related to a capture session associated with capture of the media content. In some embodiments, the context may be related to an event associated with capture of the media content. In some embodiments, the context may be related to a media presentation associated with capture of the media content. The media content may include video content, audio content, one or more images, a sequence of images, and/or other media content.

In some embodiments, an encoder (e.g., a video encoder) may integrate a context identifier with media content and/or a decoder (e.g., a video decoder) may determine a context identifier integrated with media content. In some embodiments, the context identifier may be associated with a defined type of entity group. Media content (e.g., content items and/or tracks mapped a defined type of entity group may belong to the same context (e.g., where the context can be identified by additional information in a file), the same presentation, the same capture session, and/or the same event (e.g., a dance event, a music concert event, etc.). In some embodiments where content items and/or tracks which belong to the same context, presentation, capture session, and/or event are stored in separate files, the entity group may include the context identifier. In some embodiments, an entity group may include one or more context identifiers indicating that the items and/or tracks in the entity group may correspond to one or more contexts. For example, a background image may correspond to one or more events.

In some embodiments, image items (potentially in multiple files) sharing the same context identifier may be marked as belonging to the same capture session or event. For example, multiple files captured from different angles of an object may be marked as belonging to the same capture session or event. In another example, multiple files captured from the same scene or the same photographic event captured with multiple cameras or settings may be marked as belonging to the same capture session or event.

In some embodiments, if two or more image items belonging to different files, the two or more image items may include the same context identifier. In some embodiments, if two or more image items belonging to different files, the two or more image items may be associated with CameraExtrinsicMatrixProperty boxes containing the same coordinate system identifier.

In some embodiments, a ContextIdentifierGrouping entity group may contain information regarding the context for which the context identifier is present. For example, tracks in a file having the same context identifier may be merged such that the tracks belong to the same presentation. In another example, tracks and/or content items in a file having the same context identifier may be captured from the same event. In another example, tracks and/or content items in a file having the same context identifier may be from the same capture session. In another example, tracks and/or content items in a file having the same context identifier may belong to the same 3D representation of a scene/object

In some embodiments, an item associated with a defined identifier may correspond to a collection item, an aggregate item, or a group item. In some embodiments, the collection item, the aggregate item, or the group item can be used to include an item from another HEIF file as defined by a respective item related structure in a corresponding MetaBox. In some embodiments, the item being referred to from the collection item, the aggregate item, or the group item may be an external item. In some embodiments, the file containing the collection item, the aggregate item. or the group item may be a referring file. In some embodiments, the file containing the external item may be the referred file. In some embodiments, the referred file may be a HEIF compliant file or a multi-image application format (MIAF) compliant file. In some embodiments, the referred file may contain other items which may or may not be referred by the referring file. In some embodiments, the item property of the external item may be modified by associating different item properties to the collection item, the aggregate item, or the group item in the referring file. In some embodiments, item properties associated with the external item in the referred file may be applied in the order it is associated and the item properties (if any) may be associated with the collection item, the aggregate item, or the group item in the referring file is applied. In some embodiments, the item related boxes in the MetaBox of the external item may be overridden or augmented. In some embodiments, the item related boxes (e.g., HandlerBox, PrimaryItemBox, DataInformationBox, ItemLocationBox, ItemProtectionBox, ItemInfoBox, ItemReferenceBox, ItemPropertiesBox, ItemDataBox, GroupsListBox) present in the MetaBox in the referred files may be ignored and only the item related boxes (e.g., HandlerBox, PrimaryItemBox, DataInformationBox, ItemLocationBox, ItemProtectionBox, ItemInfoBox, ItemReferenceBox, ItemPropertiesBox, ItemDataBox, GroupsListBox) present in the MetaBox of the referring file is applied.

In some embodiments, item references and entity groups (e.g., entity group only other than ContextIdentifierGrouping may be ignored) if the referred files are ignored such that item references and entity groups defined in the referring file are considered. In some embodiments, the item_ID present in the referring file may indicate the identifier of the item and may be utilized to describe item related information relying on item_ID identifiers (e.g., Item reference, Item info, etc.) within the referring file. In some embodiments, the item_ID present in the referring file to identify external item may allow defining item relations or entity groups independently from the identifiers used in the referred file(s). In some embodiments, a new fragment identifier may be defined to access the entities (e.g., tracks and/or content items) which belong to an event, presentation, capture session, and/or context.

As such, by providing media content based on context, the efficiency and/or effectiveness of resource use may be improved. Additionally, by providing media content based on context, a bit rate for video compression/coding, an amount of signaling, transmission-side (TX-side) and/or receiver-side (RX-side) computational complexity, an amount of data to be transmitted by a transmitter device, and/or an amount of data received by a receiver device may be reduced. Moreover, coding efficiency may be improved for a video encoder and/or a video decoder by providing media content based on context.

By providing media content based on context, improved authoring, content preparation, and/or content delivery may be provided for content items and/or tracks. In some embodiments, a new file description box can be generated or a current file description box can be extended with supplemental information to enable processing of two or more file (e.g., two or more ISOBMFF files, two or more HEIF files, etc.) for video coding and/or decoding. In some embodiments, providing media content based on context may enable adding a new language track (e.g., audio or subtitles) to a file without having to rewrite the video part. In some embodiments, providing media content based on context may enable a reduction in complexity for authoring of track groups and metadata without having to rewrite the entire file. In some embodiments, providing media content based on context may enable generation of a presentation from already authored track files (e.g., encoder output, CMAF recording, etc.). In some embodiments, providing media content based on context may enable generation of generic files (e.g., templates) referring to media tracks. some embodiments, providing media content based on context may enable a reduction in cost for generating DASH content preparation. For example, a single ‘moov’ can be constructed with all proper information (e.g., kind, language, dependencies, etc.) from external files by providing media content based on context. However, it is to be appreciated that one or more other technical improvements associated with video coding and/or video decoding may be enabled by providing media content based on context.

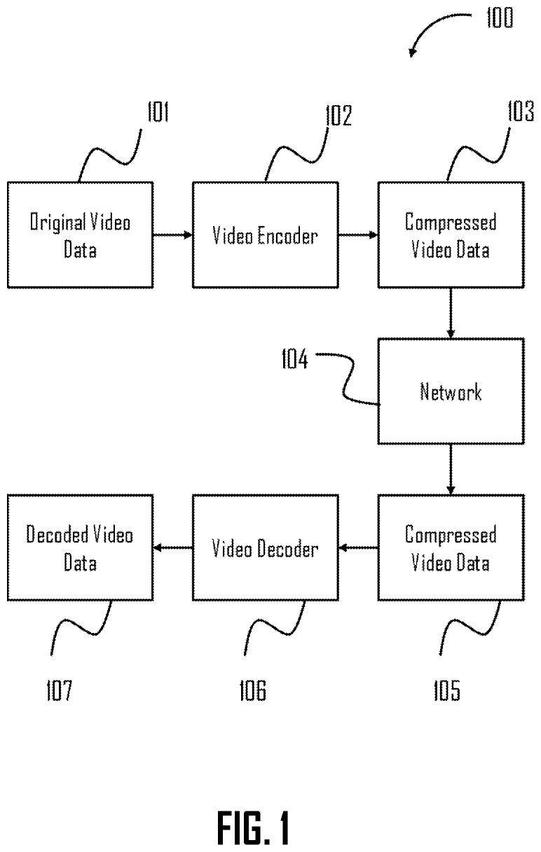

Certain video coding system related to video coding and/or video decoding are explained with reference to FIGS. 1 to 4.

FIG. 1 shows a process 100 in which video compression is applied. The process 100 can comprise generating, recording, rendering, receiving, retrieving, or otherwise providing original video data 101. The original video data 101 can be encoded by a video encoder 102, using, e.g., one or more algorithms. Algorithms, such as Discrete Cosine Transform-based video compression algorithms, e.g., MPEG-2, MPEG-4, H.263, and H.264, can be used by the video encoder 102 to encode the original video data 101. The output from the video encoder 102 is compressed video data 103. Compressed video data 103 is sent to a network 104 that provides the compressed video data 105 to a video decoder 106. The video decoder 106 decodes the compressed video data 105 to generate decoded video data 107, which is approximately equivalent to the original video data 101.

The video encoder 102 compresses the original video data 101 in such a way that the compressed video data 103 does not exceed an available bandwidth of the network 104 in order for the video decoder 106 to be able to receive and decode the compressed video data 105. However, communication bandwidth may vary depending on the type of the network 104. For example, the available communication bandwidth of an Ethernet is different from that of a wireless local area network (WLAN). The network 104, which may be e.g., a cellular communication network, may have a very narrow bandwidth. Thus, it can be important to generate compressed video data 103 at various bit-rates from the same original video data 101, such as by using scalable video coding. Scalable video coding is a video compression technique that allows video data to provide scalability. Scalability is the ability to generate video sequences at different resolutions, frame rates, and qualities from the same compressed bitstream. In some embodiments, the video encoder 102 can achieve temporal scalability can be provided using, e.g., Motion Compensation Temporal filtering (MCTF), Unconstrained MCTF, Successive Temporal Approximation and Referencing, and/or the like. In some embodiments, the video encoder 102 can achieve Signal-to-Noise Ratio (SNR) scalability or Signal-to-Noise-plus-Interference Ratio (SNIR) scalability using, e.g., Embedded ZeroTrees Wavelet (EZW), Set Partitioning in Hierarchical Trees (SPIHT), Embedded ZeroBlock Coding (EZBC), Embedded Block Coding with Optimized Truncation (EBCOT), etc. In some embodiments, the video encoder 102 can transmit only a portion of a scene, image, or picture need be transmitted as compressed video data 105 to the video decoder 106, which may improve bit-rate efficiency of video compression/coding.

In some embodiments, the video encoder 102 can achieve spatial scalability by using, e.g., a wavelet transform algorithm or multi-layer coding. For example, in some embodiments the video encoder 102 can use a multi-layer bitstream to transmit different portions of a scene, image, picture, inlay, overlay, background imagery, and/or the like, as separate layers, overlays, textures, alphas, or the like, to the video decoder 106 via the network 104.

When the video encoder 102 uses a multi-layer bitstream to transmit different portions of a scene, image, picture, inlay, overlay, background imagery, and/or the like, as separate layers, overlays, textures, alphas, or the like, to the video decoder 106 via the network 104, the video encoder 102 must typically provide metadata before, with, or after transmitting a portion or component of the multi-layer bitstream. For example, metadata may include bitstream information, such as attributes of a frame, overlay, layer, texture, alpha, or the like. In some embodiments, the metadata can be provided in a network abstraction layer (NAL) unit, e.g., in accordance with the H.264/AVC and HEVC video coding standards, the entire disclosures of which are hereby incorporated herein by reference in their entireties for all purposes.

Among other elements of the metadata, supplemental enhancement information (SEI) can be provided as additional data inserted into the multi-layer bitstream to convey information that may be helpful for the network 104 to properly transmit the compressed video data 105 to the video decoder 106. Additionally or alternatively, SEI can be provided as additional data inserted into the multi-layer bitstream to convey information that may be helpful for the video decoder 106 to properly synchronize related audio and video content from the multi-layer bitstream, properly orient the video content from among the layers, determine a proper texture overlay order, determine characteristics about each layer such as whether a texture overlay/layer includes displayable content in every portion/region of the texture overlay/layer, etc.

In some embodiments, the video encoder 102 may insert at least a content item and one or more context identifiers into a file associated with the original video data 101 during encoding and/or transmission of one or more portions of the original video data 101. The file may be configured with a predefined digital container format for media content. For example, the file may be a HEIF file, an ISOBMFF file, or another type of container file data structure for one or more portions of the original video data 101. The content item may include one or more portions of the original video data 101. For example, the content item may include media content such as video content, audio content, one or more images, a sequence of images, and/or other media content. In some embodiments, a context identifier comprises a capture session identifier for a capture session associated with capture of one or more portions of the original video data 101. In some embodiments, a context identifier comprises an event identifier for an event associated with capture of one or more portions of the original video data 101. In some embodiments, a context identifier comprises a presentation identifier for a media presentation associated with capture of one or more portions of the original video data 101. In some embodiments, a context identifier comprises a global session identifier associated with pose information used for capture of one or more portions of the original video data 101. The pose information may be related to pose of an entity. In some embodiments, the pose information includes position information and orientation information related to capture of one or more portions of the original video data 101. For example, the pose information may include camera extrinsic matrix information related to capture of one or more portions of the original video data 101. As such, the pose information may be associated with a pose of an entity expressed by camera extrinsic matrix information. In some embodiments, the entity may be a capture device. For example, an entity used for capture of one or more portions of the original video data 101 may be a camera sensor, an audio microphone, a Light Detection and Ranging (LiDAR) device, or time of flight sensor. In some embodiments, pose of an entity used for capture of one or more portions of the original video data 101 may be express in the same coordinate space. In some embodiments pose of an entity used for the capture of or more portions of the original video data 101 may be express by a Global Positioning System (GPS) position together with orientation of the entity.

In some embodiments, the video encoder 102 may insert a session indicator that specifies a type of context identifier for a corresponding context identifier of the file. In some embodiments, the video encoder 102 may insert the one or more context identifiers into a Metabox data structure of the file. For example, the Metabox data structure may be a metadata identifier box for the file. In some embodiments, the video encoder 102 may insert the one or more context identifiers into a Moviebox data structure of the file. For example, the Moviebox data structure may be a movie presentation identifier box for the file.

In some embodiments, a context identifier inserted by the video encoder 102 is a URI.

In some embodiments, a context identifier inserted by the video encoder 102 is a tag URI which may comply with IETF RFC 4151. For example, a tag URI may include an authority name, a timestamp, and/or a date stamp. Additionally, the tag URI may include additional specification. In some embodiments, an authority name may identify a provider that included the context identifier and/or a timestamp/date stamp when the context identifier was assigned. In some embodiments, a timestamp and/or a date stamp may be utilized to distinguish among different versions of a context identifier that is otherwise the same.

In some embodiments, the video decoder 106 may receive a file that includes at least a content item and one or more context identifiers during decoding and/or transmission of one or more portions of the compressed video data 105. For example, the video decoder 106 may identify one or more context identifiers in a file during decoding and/or transmission of one or more portions of the compressed video data 105. The file may be configured with a predefined digital container format for media content. For example, the file may be a HEIF file, an ISOBMFF file, or another type of container file data structure for one or more portions of the original video data 101. The content item may include one or more portions of the original video data 101.

In some embodiments, the content item may include media content such as video content, audio content, one or more images, a sequence of images, and/or other media content.

In some embodiments, the content item may include media content such as a point cloud or sequence of point clouds.

In some embodiments, the content item may include media content such a mesh or sequence of meshes.

In some embodiments, the content item may include a 3D content represented by gaussian splats or sequence of gaussian splats.

In some embodiments, a context identifier comprises a capture session identifier for a capture session associated with capture of one or more portions of the original video data 101. In some embodiments, a context identifier comprises an event identifier for an event associated with capture of one or more portions of the original video data 101. In some embodiments, a context identifier comprises a presentation identifier for a media presentation associated with capture of one or more portions of the original video data 101. In some embodiments, a context identifier comprises a global session identifier associated with pose information (e.g., pose of an entity expressed by camera extrinsic matrix information) used for capture of one or more portions of the original video data 101. In some embodiments, a context identifier is a URI. In some embodiments, a context identifier is a tag URI which may comply with IETF RFC 4151. For example, a tag URI may include an authority name, a timestamp, and/or a date stamp. Additionally, the tag URI may include additional specification. In some embodiments, an authority name may identify a provider that included the context identifier and/or a timestamp/date stamp when the context identifier was assigned. In some embodiments, a timestamp and/or a date stamp may be utilized to distinguish among different versions of a context identifier that is otherwise the same

In some embodiments, the video decoder 106 may identify a session indicator of the file that specifies a type of context identifier for a corresponding context identifier of the file. In some embodiments, the video decoder 106 may identify the one or more context identifiers in a Metabox data structure of the file. For example, the Metabox data structure may be a metadata identifier box for the file. In some embodiments, the video decoder 106 may identify the one or more context identifiers in a Moviebox data structure of the file. For example, the Moviebox data structure may be a movie presentation identifier box for the file.

In some embodiments, a Metabox data structure of a file may be a container box that extends a FullBox data structure of an ISOBMFF file. For example, a Metabox data structure may comprise the following syntax:
aligned(8) class MetaBox (handler_type)
   extends FullBox(‘meta’, version=0, 0) {
   HandlerBox(handler_type) theHandler;
   PrimaryItemBox primary_resource; // optional
   DataInformationBox file_locations; // optional
   ItemLocationBox item_locations; // optional
   ItemProtectionBox protections; // optional
   ItemInfoBox item_infos; // optional
   IPMPControlBox IPMP_control; // optional
   ItemReferenceBox item_refs; // optional
   ItemDataBox item_data; // optional
   Boxother_boxes[ ]; // optional

In some embodiments, the one or more context identifiers may be added as an additional element of the Metabox data structure. For example, the one or more context identifiers may correspond to a “item_context” element of the Metabox data structure.

In some embodiments, metadata items are identified by item_ID. Within a given MetaBox, a given item_ID shall uniquely refer to a single item. When an item is updated in movie fragments, the item_ID refers to the latest received version. Derived specifications may further enable the criteria for uniqueness: unique among the item_IDs in both file and movie-level boxes, or unique within that set extended with the track_ID of the tracks in a movie box. In some embodiments, there may be one or more scopes for item_IDs: file and segments; MovieBox and MovieFragmentBox; and/or TrackBox and TrackFragmentBox. As such, there may be one item with a given item_ID within a given scope (e.g. in the TrackBox and all TrackFragmentBox with the same track_ID).

In some embodiments, the structure or format of the metadata may be declared by the handler. In a scenario where the primary data is identified by a primary item, and that primary item has an item information entry with an item_type, the handler type may be the same as the item_type. The ItemPropertiesBox may enable the association of any item with an ordered set of item properties. Item properties may be regarded as small data records. The ItemPropertiesBox consists of two parts: ItemPropertyContainerBox that contains an implicitly indexed list of item properties, and one or more ItemPropertyAssociationBox(es) that associate items with item properties.

A multi-layer bitstream (such as for scalable coded video) may contain different layers comprising different image sequences, overlay sequences, texture sequences, and/or the like. For example, a scalable coded video bitstream may comprise different layers each containing different representations of an original image sequence. In one specific example, a first layer in the multi-layer bitstream can contain a relatively lower quality version of an original image sequence, and a second layer in the multi-layer bitstream can contain a relatively higher quality version of the original image sequence. In a second specific example, a first layer in the multi-layer bitstream can contain a first image sequence of background images, and a second layer in the multi-layer bitstream can contain a second image sequence of foreground images to be overlayed over respective background images from the first image sequence of background images. Other examples will be readily apparent to those skilled in the art, such as more sophisticated examples that include a plurality of different image layers within the multi-layer bitstream, one or more alpha representations, initialization values for a target picture to be rendered (e.g., at the video decoder 106), a combination of these, and/or the like. In some embodiments, SEI can be provided in a SEI Raw Byte Sequency Payload as a detached NAL unit.

Various SEI messages can be used to indicate/signal various information between the video encoder 102 and the video decoder 106. For example, information about camera-captured content, such as a shutter interval used, can be conveyed to the video decoder 106 using a Shutter Interval Information SEI message. Information such as parameters of annotated regions using bounding boxes can be communicated to the video decoder 106 using an Annotated Regions SEI message. Other information or parameters associated with video content being transmitted by the video decoder 106, such as content light level information, equirectangular projection information, fisheye information, color content volume information, color remapping information, motion-constrained tile set (MCTS) information, cubemap projection information, sphere rotation information, region-wise packing information, omnidirectional viewport information, SEI manifest information, SEI prefix information, and/or the like, can be communicated by one or more other SEI messages.

Some metadata and/or other enhancement information can be provided via in-band and/or SEI messages. For example, information about a recovery point in a group of pictures (GOP) or sequence of NAL units, can be indicated suing a presentation time stamp or decoding time stamp identifier, NAL unit identifier, frame number, etc. A Recovery Point SEI message can be used to provide such information. An I-frame/slice (intra-coded picture) can be provided before/between P-frames/slices (predicted pictures) and/or B-frames/slices (bidirectional predicted pictures) to indicate a latest recovery point as the latest decoded I-frame/slice. Under the H.264 video coding standard, in addition to I-frames/slices, P-frames/slices and/or B-frames/slices, switching I-frames/slices, switching P-frames/slices, and multi-frame motion estimation frames/slices can be provided. In other instances, a recovery point can be indicated in, e.g., the Recovery Point SEI message, that indicates a recovery point objective, system restore point, orphaned recovery point, recovery point chain, etc.

In some embodiments, for files that include one or more context identifiers, fragment identifiers may also be utilized for ISO base media resources. The fragment identifiers may be utilized for any media resource conformant to the ISO base media file format. Additionally, the fragment identifiers may be associated with content items or tracks. In some embodiments, a syntax name in angle brackets, e.g. “track_ID=<track_ID>”, may be replaced by the decimal string representation of the value of the indicated syntax element, e.g. “track_ID=23”.

In some embodiments, a fragment identifiers for ISOBMFF resources may consist of either: track_ID=<track_ID>, identifying the track with the given track_ID; item_ID=<item_ID>, identifying the item of the MetaBox at the file level that has the given id; item_name=<item_name>, identifying the item of the MetaBox at the file level that has the given name (as provided in the ItemInfoBox); item_ID=<item_ID>, identifying the item of the MetaBox at the movie level that has the given id; item_name=<item_name>, identifying the item of the MetaBox at the movie level that has the given name (as provided in the ItemInfoBox); track_ID=<track_ID>/item_ID=<item_ID>, identifying the item that has the given id in the MetaBox located in the track with the given track_ID; track_ID=<track_ID>/item_name=<item_name>, identifying the item that has the given name (as provided in the ItemInfoBox) in the MetaBox located in the track with the given track_ID; or group_id=<group_id>, identifying the entity group that has the given id in the EntityToGroupBox.

For fragment identifiers identifying items in MetaBoxes at the track or movie level, the identifier or name may identify items stored in movie fragments. If a fragment within a contained item is to be addressed, then the initial “#” character of that fragment shall be replaced by “*”. For example, if the URL for the desired resource when it is not in an item is /example.html#secure, then when that same resource is in an item the URL might be /container#item_name=example.html*secure.

In some embodiments, an ExternalTrackBox can be used to include a track from another ISO Base Media file, as defined by its TrackBox and other track-related structures. The track being referred to is called an external track. The file containing the ExternalTrackBox may correspond to the referring file, and the file containing the external track may correspond to the referred file. Referred files may correspond to ISOBMFF compliant files. External tracks may be fragmented or not, independently of whether the referring file is fragmented or not. The timeline of an external track may be modified by an edit list in the referring file. In some embodiments, the UserDataBox and MetaBox of an external track can be overridden or augmented. UserDataBox present at movie level or MetaBox present at file or movie level in the referred files shall be ignored, and only UserDataBox present at movie level or MetaBox present at file or movie level, if any, of the referring file shall apply. In some embodiments, track references and track groups of the referred files are ignored and only track references and groups (track groups or entity groups) defined in the referring file are valid. In some embodiments, the track_ID of the TrackHeaderBox present in ExternalTrackBox gives the identifier of the track in the referring file and can be used to describe track references, track groups and other track relationships relying on track identifiers within the referring file. This allows defining track relations or track groups independently from the identifiers used in the referred file(s). In some embodiments, the TrackHeaderBox provides the presentation information of the external track within the presentation of the referring file, such as track width/height, matrix, volumes and track flags.

In some embodiments, an external track processing model and/or a file reader may process an external track by identifying whether the referring file can be processed (e.g., brands, track handler types). In some embodiments, an external track processing model and/or a file reader may process an external track by identifying whether it should take the track into consideration. In some embodiments, an external track processing model and/or a file reader may process an external track by loading a referred file if an external track is selected for processing.

In some embodiments, a capture session identifier item property allows a file writer to associate an image item with a session identifier. In some embodiments, image items (e.g., potentially in multiple files) sharing the same session identifier may be marked as belonging to the same session or event. Example use cases are multiple files captured from different angles of an object, or the same scene or photographic event captured with multiple cameras or settings. In some embodiments, two or more image items belonging to different files may share the same capture session identifier.

In some embodiments, a CreationTimeProperty item property may be utilized to signal the capture time of the image items associated with a specific session identifier. For example, the following syntax may be utilized:
aligned(8) class CaptureSessionIdentifierProperty
extends ItemFullProperty(‘casi’, version=0, flags) { int has_uuid=flags & 0x1==1; if (has_uuid) {
   unsigned int(8) session_uuid[16];
   }
   else { utf8string session_uri; }}

In some embodiments, flags equal to 1 specifies that the property contains a session_uuid rather than a session_uri. In some embodiments, session_uri specifies a Uniform Resource Name (URI) that identifies the global session or event that this image item belongs to. URI's of type “urn:uuid:XYZ” should instead be directly specified as a session_uuid. In some embodiments, session_uuid specifies a UUID that identifies the global session or event that this image item belongs to. Specifying a session_uuid is equivalent to specifying a session_uri of type “urn:uuid:XYZ”. In some embodiments, a new version to the CameraExtrinsicMatrixProperty that adds a global session UUID may be added for linking the coordinate spaces between files.

In some embodiments, a Moviebox data structure of a file (e.g., a ISOBMFF file) includes a MoviePresentationIdentifierBox data structure. The MoviePresentationIdentifierBox data structure may include one or more unique identifiers for a movie in the file. In some embodiments, the following values may be defined for one or more flag fields of the MoviePresentationIdentifierBox: TRACK_MERGE_PROCESS and/or presentation_ID.

For the TRACK_MERGE_PROCESS (e.g., when TRACK_MERGE_PROCESS is set), if the track IDs overlap in files having the same presentation_ID, then the non-overlapping samples in decoding time and respective track metadata may be selected from any of these tracks. The selected samples and metadata are in a manner that there may be a sync sample when a switch to another of these tracks takes place. When the track IDs differ in the files having the same presentation_ID, the tracks may be combined to a single file. Otherwise (e.g., when TRACK_MERGE_PROCESS is not set), no merging process is specified. The presentation_ID present in the MoviePresentationIdentifierBox may be utilized for determining that different files are part of the same presentation. If a track belongs to two or more different presentations, multiple presentation_IDs may be present in the MoviePresentationIdentifierBox which can be then mapped to different presentations.

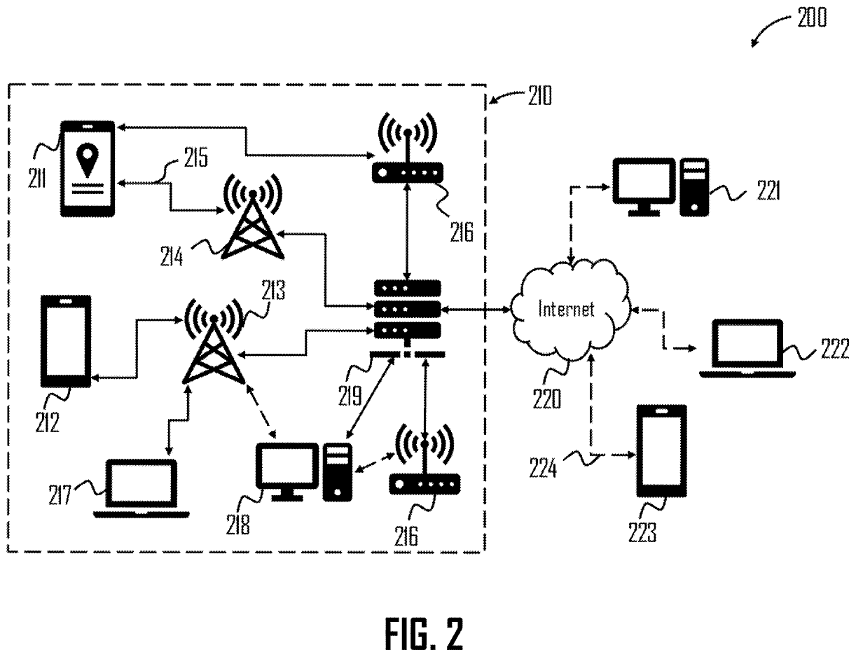

FIG. 2 illustrates a system 200, according to an embodiment, within which embodiments of the present invention can be utilized is shown. The system 200 comprises multiple communication devices which can communicate through one or more networks. The system 200 may comprise any combination of wired or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

The system 200 may include both wired and wireless communication devices and/or electronic devices suitable for implementing select, various, or all of the embodiments described herein. For example, the system 200, as shown in FIG. 2, is illustrated as comprising a mobile network 210 and a representation of the internet 220. The mobile network 210 can be or comprise, e.g., a fourth generation (4G) network, a Long Term Evolution (LTE), a fifth generation (5G) network, a sixth generation (6G) network, and/or the like. Connectivity to the internet 220 may include, but is not limited to, long range wireless connections, short range wireless connections, and various wired connections including, but not limited to, telephone lines, cable lines, power lines, and similar communication pathways.

The example communication devices shown in the system 200 may include, but are not limited to, an electronic device or apparatus, such as mobile device 211, user equipment 212, etc. User equipment 212 can be connected to the internet 220 by way of at least an access point 213, which may be or comprise a gNodeB (gNB), an eNodeB (eNB), base station, access network node, radio access network (RAN) node, and/or the like. The mobile device 211 can be connected to the internet 220 by way of at least a cell tower 214, e.g., via radio signaling 215 with the cell tower 214, short messaging service (SMS) with the cell tower 214, and/or the like.

Additionally or alternatively, the mobile device 211 and/or user device 212 can be connected to the internet 220 by way of a WiFi access point 216 or the like. Access point 213, cell tower 214, and/or WiFi access point 216 can be configured to communicate directly with the internet 220 or with the internet 220 by way of a network server 219, which can comprise, be comprised in, hosted on, or otherwise functionalized via any suitable network-side device. Such network-side devices can include, but are not limited to, a server, a computing device, a centralized processing unit (CPU), a graphics processing unit (GPU), a processor, processing circuitry, a controller, a network element, a virtualized network function, a mobility management entity (MME), a serving gateway (SGW), a packet data network (PDN) gateway (PGW), a home subscriber server (HSS), a public data network (PDN), an access and mobility management function (AMF), a user plane function (UPF), a data network (DN), an authentication server function (AUSF), a session management function (SMF), a network slice selection function (NSSF), a network exposure function (NEF), a network function repository function (NRF), a policy control function (PCF), a unified data management (UDM) function, an application function (AF), or any other suitable network-side device, element, function, hardware, device, etc.

In the system 200, electronic devices such as, e.g., 211, 212, 217, etc. may be stationary or mobile when carried by an individual who is moving. For example, the user equipment 212 can be or comprise a head-mounted display, a body-worn display, an immersive gaming system, a smartphone, a laptop (e.g., 217), or the like. In other embodiments, electronic devices in the system 200, such as 211, 212, 217, can be mobile by virtue of being located in, mounted on, coupled to, or otherwise supported by a device configured for transportation, including, but not limited to, a car, a truck, a taxi, a bus, a train, a boat, an airplane, a bicycle, a motorcycle, or any similar suitable mode of transport. In other embodiments, the computing device 218 can also be stationary or can be configured to be used while stationary and while mobile, or to be operationally or configurationally switched from a mobile use mode to a stationary use mode. For example, in embodiments in which the user device 212 is or comprises a head mounted display, the user device 212 may be effectively used by a user wearing the user device 212 while the user is stationary or while the user is moving.

Additionally or alternatively, electronic devices in the system 200 can be stationary. For example, the system 200 can comprise a computing device 218, which can be or comprise a gaming console, a desktop computer, a three-dimensional gaming system, a virtual reality display system, an augmented reality display system, an interactive-display system, an image projection system, and/or the like. In other embodiments, the computing device 218 can also be mobile or can be configured to be used while stationary and while mobile, or to be operationally or configurationally switched from a stationary use mode to a mobile use mode.

In some embodiments, one or more of the electronic devices in the system 200, e.g., one of 211, 212, 217, 218 may be or comprise a set-top box, a digital TV receiver, a device configured to transmit/receive streaming content or audio/video via a bitstream, etc., but which may/may not have a display or wireless capabilities, in tablets or (laptop) personal computers (PC), which have hardware or software or combination of the encoder/decoder implementations, in various operating systems, and in chipsets, processors, DSPs and/or embedded systems offering hardware/software based coding.

In some embodiments, certain electronic devices (e.g., 211, 212, 217, 218) in the system 200 may be configured to send and receive calls and messages and communicate with service providers through a wireless connection, such as 215, to the cell tower 214 or the access point 213. The cell tower 214 and/or the access point 213 may be connected to the network server 219 that allows communication between the mobile network 210 and the internet 220. The system 200 may include additional communication devices and communication devices of various types, such as electronic devices 221, 222, and 223, which may be outside of the mobile network 210 but nevertheless connected to the internet 220, e.g., by way of a wired or wireless connection 224.

The various communication devices (e.g., 211, 212, 217, 218, 221, 222, 223) illustrated in the system 200 of FIG. 2 may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Among other transmissions between two or more of the communication devices (e.g., 211, 212, 217, 218, 221, 222, 223) illustrated in the system 200 of FIG. 2, video and/or audio transmissions can be carried out. In order to improve the efficiency and/or effectiveness of resource use, reduce bit-rate, reduce and/or improve signaling, and reduce transmission-side (TX-side) and/or receiver-side (RX-side) computational complexity, data to be transmitted can be compressed (i.e., encoded) at the TX-side and decoded at the RX-side. To carry out such video/audio data compression, a coder/decoder device (i.e., codec), or one or more codecs, can be used. In some embodiments, the video encoder 102 and/or video decoder 106 described above with reference to FIG. 1 can comprise at least one codec.

Real-time Transport Protocol (RTP) is widely used for real-time transport of timed media such as audio and video. RTP may operate on top of the User Datagram Protocol (UDP), which in turn may operate on top of the Internet Protocol (IP). RTP is specified in Internet Engineering Task Force (IETF) Request for Comments (RFC) 3550, available from www.ietf.org/rfc/rfc3550.txt. In RTP transport, media data is encapsulated into RTP packets. Each media type or media coding format may have a dedicated RTP payload format.

An RTP session is an association among a group of participants communicating with RTP. It is a group communications channel which can potentially carry a number of RTP streams. An RTP stream is a stream of RTP packets comprising media data.

Communication systems may include any number of media-aware network elements (MANEs). For example, many multipoint audio-visual conferences operate utilizing a centralized unit called Multipoint Control Unit (MCU). An MCU may implement the functionality of an RTP translator or an RTP mixer. An RTP translator may be a media translator that may modify the media inside the RTP stream. A media translator may for example decode and re-encode the media content (i.e. transcode the media content). An RTP mixer is a middlebox that aggregates multiple RTP streams that are part of a session by generating one or more new RTP streams. An RTP mixer may manipulate the media data. One common application for a mixer is to allow a participant to receive a session with a reduced amount of resources compared to receiving individual RTP streams from all endpoints. A mixer can be viewed as a device terminating the RTP streams received from other endpoints in the same RTP session. Using the media data carried in the received RTP streams, a mixer generates derived RTP streams that are sent to the receiving endpoints. In another example, a MANE is a selective forward unit (SFU) that selectively forwards incoming RTP packets from one or more senders to one or more receivers.

According to some embodiments, a video codec can consist of an encoder that transforms the input video into a compressed representation suited for storage/transmission and/or a decoder that can uncompress the compressed video representation back into a viewable form. A video encoder (e.g., 102) and/or a video decoder (e.g., 106) may be combined within a singular device or can be separate from each other, i.e. need not form a codec within a singular device. Typically, a video encoder (e.g., 102) discards some information in the original video data 101 in order to represent the original video data 101 in a more compact form (that is, at a lower bit-rate).

Hybrid video encoders, for example many encoder implementations of ITU-T H.263 and H.264, often may encode the original video data 101 in two or more phases. According to some embodiments, pixel values in a certain picture area (or “block”) are initially predicted for example by motion compensation means (finding and indicating an area in one of the previously coded video frames that corresponds closely to the block being coded) or by spatial means (using the pixel values around the block to be coded in a specified manner), and thereafter a prediction error, i.e. the difference between the predicted block of pixels and the original block of pixels, is coded. This can be done by transforming the difference in pixel values using a specified transform (e.g. Discrete Cosine Transform (DCT), a DCT algorithm, or a variant of the same), quantizing the coefficients, and entropy coding the quantized coefficients. By varying the fidelity of the quantization process, the video encoder (e.g., 102) can control the balance between the accuracy of the pixel representation (picture quality) and size of the resulting coded video representation (file size or transmission bitrate), as reflected for example in the compressed video data 103 and/or the compressed video data 105.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

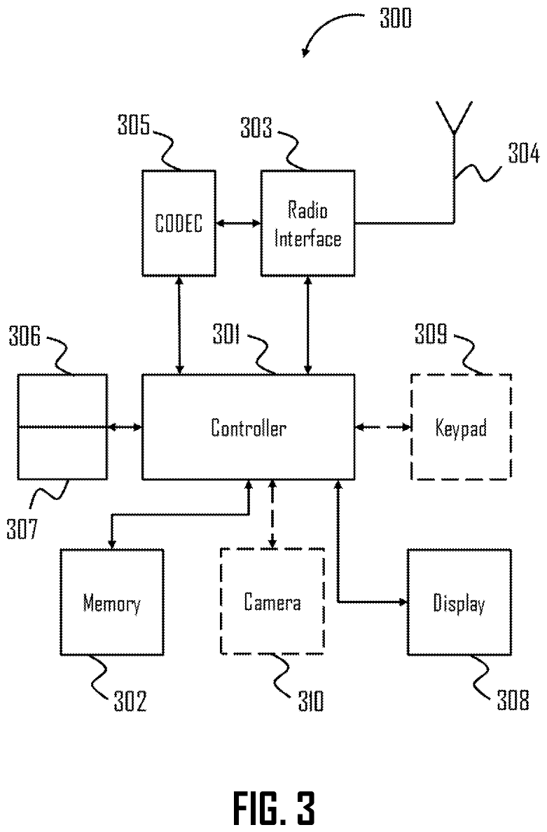

Referring now to FIG. 3, a video coding system or device is illustrated, according to an example embodiment, as a schematic block diagram of an exemplary apparatus, referred to herein as decoding device 300, which is configured to carry out at least a portion of the video compression/encoding/decoding processes and tasks described herein, e.g., 100.

The decoding device 300 may for example be configured to function as the video decoder 106. In other embodiments, the decoding device 300 can be, comprise, or be comprised within, e.g., mobile device 211, user equipment 212, computing device 217, or computing device 218 in the wireless network 210. In other embodiments, the decoding device 300 can be, comprise, or be comprised within a heads-up display, a head-mounted display, a gaming console, a user's computer, and/or the like. However, it will be appreciated that embodiments of the invention may be implemented within any electronic device or apparatus which may require encoding and decoding, or encoding or decoding, of video images, multi-layer bitstreams, scalable coded video, bitstreams comprising audio and video, bidirectional bitstreams, conversational content bitstreams, non-conversational content bitstreams, and/or the like.

The decoding device 300 may comprise a controller 301 in operable communication with a memory 302 and a radio interface 303. The decoding device 300 can be further may comprise a display 308, e.g., in the form of a liquid crystal display (LCD), light emitting diode (LED) display, organic LED (OLED) display, plasma display, Active-Matrix OLED (AMOLED) display, Quantum dot LED (QLED) display, micro-LED display, augmented reality display, virtual reality display, projected image display, any combination thereof, and/or the like. In other embodiments, the display 308 may be any other display technology suitable to display an image and/or video. The decoding device 300 may, optionally, further comprise a keypad 309. In other embodiments, any suitable data or user interface mechanism may be employed. For example, a user interface may be implemented as a virtual keyboard or data entry system as part of a touch-sensitive display.

The decoding device 300 may comprise a microphone (not shown) or any suitable audio input which may be a digital or analogue signal input. The decoding device 300 may further comprise an audio output device which, in some embodiments, may be any one of: an earpiece, a speaker, or an analogue audio or digital audio output connection. The decoding device 300 may also comprise a battery (not shown). In other embodiments, the decoding device 300 may be powered by any suitable mobile energy device such as a solar cell, a fuel cell, a clockwork generator, etc. The decoding device 300 may, optionally, further comprise a camera 310 capable of recording or capturing images and/or video. The decoding device 300 may further comprise an infrared port (not shown) for short range line of sight communication to other devices. In other embodiments the decoding device 300 may further comprise any suitable short range communication solution such as for example a Bluetooth wireless connection or a USB/firewire wired connection.

According to some embodiments, the controller 301 can comprise, e.g., a processor or the like configured for controlling at least some aspects, functionalities, equipment, subcomponents, or subsystems of the decoding device 300. The controller 301 may be connected either directly or indirectly to the memory 302 which, in some embodiments, may store both data in the form of image and audio data and/or may also store instructions for implementation on the controller 301. The controller 301 may further be connected to codec circuitry 305 and the codec circuitry 305 can be arranged and dimensioned for, operably programmed for, programmatically capable of, or otherwise suitably configured for carrying out coding and/or decoding of audio and/or video data or assisting in coding and decoding carried out by the controller 301.

The decoding device 300 may further comprise a card reader (not shown) and/or a smart card (not shown), for example a UICC and UICC reader for providing user information and being suitable for providing authentication information for authentication and authorization of the user at a network (e.g., 210).

The decoding device 300 may comprise radio interface circuitry 303 connected to, or otherwise in operable communication with, the controller 301. The radio interface circuitry 303 can be arranged and dimensioned for, operably programmed for, programmatically capable of, or otherwise suitably configured for generating wireless communication signals for example for communication with a cellular communications network, a wireless communications system, or a wireless local area network. The decoding device 300 may further comprise an antenna array 304 connected to the radio interface circuitry 303 for transmitting radio frequency signals generated at the radio interface circuitry 303 to other apparatus(es) and for receiving radio frequency signals from other apparatus(es).

The antenna array 304 can be configured to receive radio signals comprising or representing the compressed/coded audio/video content from, e.g., an encoder-side device. The antenna array 304 can relay the radio signals to the radio interface 303, which can be configured to convert the radio signals to decodable information, which it then passes along to the codec circuitry 305. The codec circuitry 305 then decodes, e.g., with the aid of, and/or upon receiving instructions from, the controller 301. The codec circuitry 305 can then, once the decodable information is decoded, provide decoded information to the controller 301. The controller 301 can interpret the decoded information to synchronize the audio/video content, and otherwise determine how to reconstitute, build, reconstruct, render, overlay, display, emit, broadcast, and/or present the decoded audio, images, and/or video frames to one or more users, either directly on the decoding device 300 (e.g., via the display 308) or by transmitting/providing the decoded audio, images, and/or video frames to another device (e.g., 211, 212, 217, 218) for display thereon.

The decoding device 300 may, optionally, further comprise a camera 310 capable of recording or detecting individual frames which are then passed to the codec 305 or the controller 301 for processing. The decoding device 300 may receive the video image data for processing from another device prior to transmission and/or storage. The decoding device 300 may also receive either wirelessly or by a wired connection the image for coding/decoding. The incorporation of the camera 310 into/with the decoding device 300 can be helpful in certain circumstances when, e.g., the image and/or video content is or comprises virtual reality content or augmented reality content in which real world objects and imagery located about the decoding device 300 or other device (e.g., 211, 212, 217, 218) displaying thereon the content may need to record and return images and/or video to assist with rendering subsequent images and/or video frames of the content for the user(s).

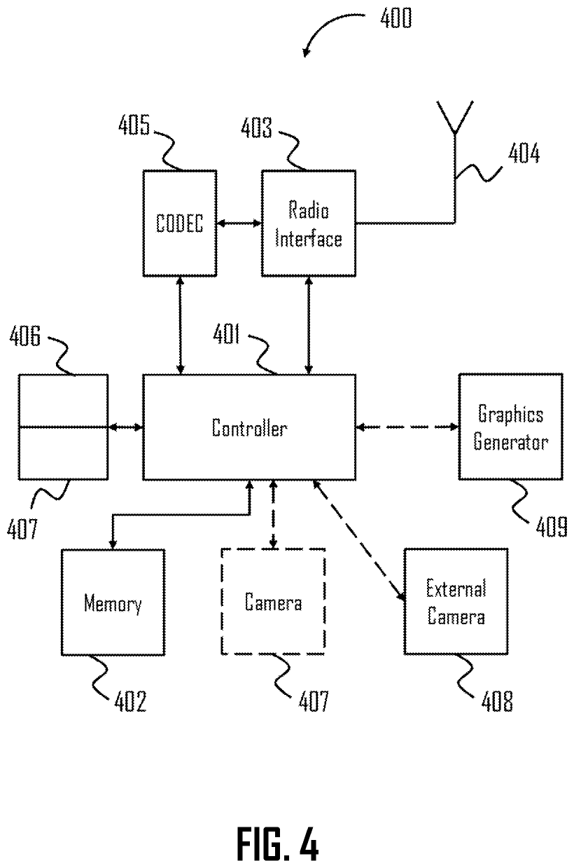

Referring now to FIG. 4, a video coding system or device is illustrated, according to an example embodiment, as a schematic block diagram of an exemplary apparatus, referred to herein as an encoding device 400, which is configured to carry out at least a portion of the video compression/encoding/decoding processes and tasks described herein, e.g., 100.

The encoding device 400 may for example be configured to function as the video encoder 102. In other embodiments, the encoding device 400 can be, comprise, or be comprised within a network-side or encoder-side device, e.g., 219. However, it will be appreciated that the encoding device 400 can be, comprise, or be comprised within another device within the mobile network (e.g., 210) in which the decoding device 300 is located. In other embodiments, the encoding device 400 can be, comprise, or be comprised within a device operationally and/or physically located outside the system or network (e.g., 210) in which the decoding device 300 is located. For example, the encoding device 400 can be, comprise, or be comprised within, e.g., 221, 222, 223, or the like. However, it will be appreciated that embodiments of the invention may be implemented within any electronic device or apparatus which may require encoding and decoding, or encoding or decoding, of video images, multi-layer bitstreams, scalable coded video, bitstreams comprising audio and video, bidirectional bitstreams, conversational content bitstreams, non-conversational content bitstreams, and/or the like.

The encoding device 400 may comprise a controller 401 in operable communication with a memory 402 and a radio interface 403. The encoding device 400 can be further may comprise codec circuitry 405 in operable communication with one or both of the controller 401 and/or the radio interface 403. The encoding device 400 can further comprise an antenna array 404 in operable communication with the radio interface 403.

In some embodiments, the encoding device 400 can be configured to capture audio and/or video content to be encoded and transmitted to a decoder-side device (e.g., 300). In such embodiments, the encoding device 400 can, optionally, comprise a camera 407, a microphone (not shown), and/or the like.

In other embodiments, the encoding device 400 can be configured to generate audio and/or video content to be encoded and transmitted to a decoder-side device (e.g., 300). In such embodiments, the encoding device 400 can, optionally, comprise a graphics generator 409.

In other embodiments, encoding device 400 can be configured to request, retrieve, or otherwise receive audio and/or video from one or more external devices, subcomponents, systems, etc. For example, the encoding device 400 can be configured to receive audio from an external microphone (not shown) or an external audio generation device (not shown). In some embodiments, the encoding device 400 can be configured to receive video from an external camera 408. Whether video content is captured by the camera 407 or by the external camera 408, these cameras are capable of recording or capturing images and/or video.

In some embodiments, the encoding device 400 can be configured to receive generated graphics or other rendered content from an external rendering device or graphics generating device, such as the graphics generator 409.

According to some embodiments, the controller 401 can be or comprise, e.g., a processor, processing circuitry, or the like, that is configured for controlling at least some aspects, functionalities, equipment, subcomponents, or subsystems of the encoding device 400. The controller 401 may be connected either directly or indirectly to the memory 402 which, in some embodiments, may store both data in the form of image and/or audio data and/or may also store instructions for implementation of the same using the controller 401. The controller 401 may further be connected to the codec circuitry 405 and the codec circuitry 405 can be arranged and dimensioned for, operably programmed for, programmatically capable of, or otherwise suitably configured for carrying out coding and/or decoding of audio and/or video data or assisting in coding and decoding carried out by the controller 401.

The radio interface circuitry 403 of the encoding device 400 can be configured to be connected to, or otherwise in operable communication with, the controller 401. The radio interface circuitry 403 can be arranged and dimensioned for, operably programmed for, programmatically capable of, or otherwise suitably configured for generating wireless communication signals for example for communication with a cellular communications network, a wireless communications system, or a wireless local area network. The encoding device 400 may further comprise the antenna 404 connected to the radio interface circuitry 403 for transmitting radio frequency signals generated at the radio interface circuitry 403 to other apparatus(es) and for receiving radio frequency signals from other apparatus(es).

The codec circuitry 405 of the encoding device 400 may be configured to receive images and/or video (e.g., as bitstream data) from the controller 401. The codec circuitry 405 can be further configured to encode/compress this image and/or video data, and optionally metadata for decoder-side use in decoding/interpreting the encoded/compressed image and/or video data. The codec circuitry 405 can then provide the encoded/compressed image and/or video data to the radio interface 403, which can convert the encoded/compressed image and/or video data to a form that can be provided/transmitted to a decoder-side device (e.g., 300) via radio signaling using the antenna array 404.

In order to ensure that the encoded/compressed image and/or video data being provided from, e.g., the encoder device 400 to the decoder device 300, is properly and synchronously encoded and decoded, standard means can be defined for how the encoded/compressed image and/or video data is encoded. Likewise, metadata that is associated with the encoded/compressed image and/or video data can likewise be provided between the encoder-side and the decoder-side (e.g., from the encoder device 400 to the decoder device 300). Standard means can also be defined for what the metadata associated with the encoded/compressed image and/or video data comprises, the form in which the metadata associated with the encoded/compressed image and/or video data is provided, how syntax used in the metadata associated with the encoded/compressed image and/or video data is selected and used, and/or how the metadata associated with the encoded/compressed image and/or video data is encoded/decoded.

In some embodiments, one or more context identifiers for a content item can be provided from the encoder device 400 as additional data inserted into a file and/or a bitstream (e.g., a multi-layer bitstream) to convey contextual information regarding capture of the content item that may be helpful for the decoder device 300 to properly decode and interpret the compressed video data 105 (e.g., encoded/compressed image and/or video data) received therewith from the encoder device 400. The one or more context identifiers can likewise be helpful for the decoder device 300, once the encoded/compressed image and/or video data is decoded, if the decoder device 300 generates displayable or renderable image(s) or video frame(s) from the encoded/compressed image and/or video data. Additionally and/or alternatively, the one or more context identifiers can be helpful for the decoder device 300 if the decoder device 300 generates data or information about the encoded/compressed image and/or video data that, when transmitted to a displaying device (e.g., 112, 113, 117, 118, etc.), enables the displaying device to generate and display displayable image(s) or video frame(s). Alternatively, the one or more context identifiers can be helpful for the decoder device 300 if the decoder device 300 generates data or information about the encoded/compressed image and/or video data that, when transmitted to a rendering device (e.g., 112, 113, 117, 118, etc.), enables the rendering device to render and display/present rendered imagery, rendered graphics, and/or rendered video frame(s).

Some key definitions, bitstream and coding structures, and concepts of some video coding standards and specifications are described in this section for providing background for a video encoder, decoder, encoding method, decoding method, and a bitstream structure, wherein the embodiments may be implemented. It is to be understood that embodiments are not limited to the referenced video coding standards or specifications.

An elementary unit for the input to an encoder and the output of a decoder, respectively, in many cases is a picture. A picture given as an input to an encoder may also be referred to as a source picture, and a picture decoded by a decoded may be referred to as a decoded picture or a reconstructed picture.

The source and decoded pictures are each comprised of one or more sample arrays. The sample arrays of a picture may be referred to as luma (or L or Y) and chroma, where the two chroma arrays may be referred to as Cb and Cr; regardless of the actual color representation method in use. The actual color representation method in use can be indicated e.g., in a coded bitstream e.g., using the Video Usability Information (VUI) syntax of HEVC or alike. A component may be defined as an array or single sample from one of the three sample arrays (luma and two chroma) or the array or a single sample of the array that compose a picture in monochrome format.

Chroma sample arrays may be absent (and hence monochrome sampling may be in use) or chroma sample arrays may be subsampled when compared to luma sample arrays. Chroma formats comprise monochrome format and non-monochrome formats, and these may be summarized as follows:

In monochrome sampling there is only one sample array, which may be nominally considered the luma array. In 4:2:0 sampling, each of the two chroma arrays has half the height and half the width of the luma array. In 4:2:2 sampling, each of the two chroma arrays has the same height and half the width of the luma array. In 4:4:4 sampling when no separate color planes are in use, each of the two chroma arrays has the same height and width as the luma array.

Samples of a sample array have a certain bit depth, such as 8 bits per sample or 10 bits per sample. A bit depth implicitly specifies a value range, which may be referred to as the full range. For example, the full range is from 0 to 255, inclusive, for 8 bits per sample, or from 0 to 1023, inclusive, for 10 bits per sample. The source video may use allocate a narrower sample value range than the full range. A specific value range, sometimes referred to as the studio range, has been specified in the ITU-T H.273 standard specifying coding-independent code points for video. A source value range may interchangeably be referred to as a source sample value range, and may be defined as the sample value range of the video that is given as input to a video encoder to be encoded.

A picture may be defined to be either a frame or a field. A frame comprises a matrix of luma samples and possibly the corresponding chroma samples. A field is a set of alternate sample rows of a frame and may be used as encoder input, when the source signal is interlaced. A bitstream may be defined as a sequence of bits or a sequence of syntax structures. A bitstream format may constrain the order of syntax structures in the bitstream. A syntax element may be defined as an element of data represented in a bitstream. A syntax structure may be defined as zero or more syntax elements present together in a bitstream in a specified order.

Syntax structures may be specified, for example, using arithmetic, logical, relational, bit-wise, and assignment operators similar to those available in many programming languages. For example, & may indicate a bit-wise ‘AND’ operation. Furthermore, syntax structures may be specified with reference to mathematical functions.

Syntax structures and semantics may use the values of variables derived from the values of syntax elements. Naming conventions may be defined for variables. For example, variables may be named by a mixture of lower case and upper-case letter and without any underscore characters. Variables starting with an upper-case letter may be derived for the decoding of the current syntax structure and all depending syntax structures. Variables starting with an upper case letter may, in some cases, be used in the decoding process for later syntax structures without mentioning the originating syntax structure of the variable. Variables starting with a lower case letter may only be used in relation to the syntax structure or function they have been defined for.

Video coding specifications may define an elementary unit that for the output an of an encoder and/or for the input to a decoder. For example, such an elementary unit may be an open bitstream unit (OBU), as specified e.g. in AV1, or a Network Abstraction Layer (NAL) unit, as specified e.g. in HEVC or VVC.

In some video codecs, an elementary unit for the output of an encoder and the input of a decoder, respectively, may be a Network Abstraction Layer (NAL) unit. For transport over packet-oriented networks or storage into structured files, NAL units may be encapsulated into packets or similar structures. A bitstream format has been specified in some video coding standards for transmission or storage environments that do not provide framing structures. The bitstream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet-and stream-oriented systems, start code emulation prevention may always be performed regardless of whether the bitstream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

A bitstream may be defined to logically include a syntax structure, such as a NAL unit, when the syntax structure is transmitted along the bitstream but may be included in the bitstream according to the bitstream format. A bitstream may be defined to natively comprise a syntax structure, when the bitstream includes the syntax structure.

In some coding formats or standards, a bitstream may be in the form of a NAL unit stream or a byte stream, that forms the representation of coded pictures and associated data forming one or more coded video sequences.

Some or all of the elements, steps, or components of the approaches described herein can be carried out by a computing device or an apparatus comprising a processor and memory. Examples of such computing devices and apparatuses are described in more detail below. Referring now to both FIG. 3 and FIG. 4, various aspects related to the functionality of the decoder device 300 and/or the encoder device 400 and components/configurations thereof are described. Embodiments of the present invention can be implemented as an apparatus or device, such as described above with regard to one or more embodiments of the decoder device 300 and/or one or more embodiments of the encoder device 400. In other embodiments, the present invention can be implemented as a computer program product that is executable on a computing device—such as by execution of program codes or computer-readable instructions stored on at least one memory device.

Some embodiments of the present invention may be implemented in various other ways, such as an article of manufacture. One example of an article of manufacture in the context of the invention disclosed herein is a computer program product that includes one or more software components including, for example, software objects, methods, data structures, program codes, computer-readable instructions, application-specific software, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

In some embodiments, the decoding device 300 and/or the encoding device 400 according to one embodiment of the present invention. In general, the terms computing device, computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

In some embodiments, the decoding device 300 and/or the encoding device 400 may include or be in communication with one or more processing elements (also referred to as processors, processing circuitry, and/or similar terms used herein interchangeably) that communicate with other elements within the decoding device 300 and/or the encoding device 400 via a bus, for example. As will be understood, the processing element of the decoding device 300 and/or the encoding device 400 may be embodied as one or more complex programmable logic devices (CPLDs), microprocessors, multi-core processors, coprocessing entities, application-specific instruction-set processors (ASIPs), microcontrollers, and/or controllers. Further, the processing element may be embodied as one or more other processing devices or circuitry. The term circuitry may refer to an entirely hardware embodiment or a combination of hardware and computer program products. Thus, the processing element may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element may be configured for a particular use or configured to execute instructions stored in volatile or non-volatile media or otherwise accessible to the processing element. As such, whether configured by hardware or computer program products, or by a combination thereof, the processing element may be capable of performing steps or operations according to embodiments of the present invention when configured accordingly.

In one embodiment, the decoding device 300 and/or the encoding device 400 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the decoding device 300 and/or the encoding device 400 may further include or be in communication with volatile media (also referred to as volatile storage, memory, memory storage, memory circuitry and/or similar terms used herein interchangeably). In one embodiment, the volatile storage or memory may also include one or more volatile storage or memory media 404, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element. Thus, the databases, database instances, database management systems, data, applications, programs, program modules, scripts, source code, object code, byte code, compiled code, interpreted code, machine code, executable instructions, and/or the like may be used to control certain aspects of the operation of the decoding device 300 and/or the encoding device 400 with the assistance of the processing element and operating system.

In some embodiments, the decoding device 300 and/or the encoding device 400 may also include one or more network interfaces, such as a transceiver for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the decoding device 300 and/or the encoding device 400 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the decoding device 300 and/or the encoding device 400 may include or be in communication with one or more input elements, such as a keyboard input, a mouse input, a touch screen/display input, motion input, movement input, audio input, pointing device input, joystick input, keypad input, and/or the like. The decoding device 300 and/or the encoding device 400 may also include or be in communication with one or more output elements (not shown), such as audio output, video output, screen/display output, motion output, movement output, and/or the like.

The signals provided to and received from the decoding device 300 and/or the encoding device 400 may include signaling information/data in accordance with air interface standards of applicable wireless systems. In this regard, the decoding device 300 and/or the encoding device 400 may be capable of operating with one or more air interface standards, communication protocols, modulation types, and access types. More particularly, the decoding device 300 and/or the encoding device 400 may operate in accordance with any of a number of wireless communication standards and protocols, such as those described above. In a particular embodiment, the decoding device 300 and/or the encoding device 400 may operate in accordance with multiple wireless communication standards and protocols, such as UMTS, CDMA2000, 1× RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the decoding device 300 and/or the encoding device 400 may operate in accordance with multiple wired communication standards and protocols, such as those described above, via a network interface.

Via these communication standards and protocols, the decoding device 300 and/or the encoding device 400 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The decoding device 300 and/or the encoding device 400 can also download changes, add-ons, and updates, for instance, to its firmware, software (e.g., including executable instructions, applications, program modules), and operating system.

According to one embodiment, the decoding device 300 and/or the encoding device 400 may include location determining aspects, devices, modules, functionalities, and/or similar words used herein interchangeably. For example, the decoding device 300 and/or the encoding device 400 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like.

Alternatively, the location information/data can be determined by triangulating a position of the decoding device 300 and/or the encoding device 400 in connection with a variety of other systems, including cellular towers, Wi-Fi access points, and/or the like. Similarly, the decoding device 300 and/or the encoding device 400 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The decoding device 300 and/or the encoding device 400 may also comprise a user interface (that can include a display coupled to the processing element/controller) and/or a user input interface (coupled to the processing element/controller). For example, the user interface may be a user application, browser, user interface, and/or similar words used herein interchangeably executing on and/or accessible via the decoding device 300 and/or the encoding device 400 to interact with and/or cause display of information/data from the decoding device 300 and/or the encoding device 400, as described herein. The user input interface can comprise any of a number of devices or interfaces allowing the decoding device 300 and/or the encoding device 400 to receive data, such as a keypad (hard or soft), a touch display, voice/speech or motion interfaces, or other input device. In embodiments in which the decoding device 300 and/or the encoding device 400 comprises a keypad, the keypad can include (or cause display of) the conventional numeric (0-9) and related keys (#, *), and other keys used for operating the decoding device 300 and/or the encoding device 400 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The decoding device 300 and/or the encoding device 400 can also include volatile storage or memory and/or non-volatile storage or memory, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the decoding device 300 and/or the encoding device 400. As indicated, this may include a user application that is resident on the entity or accessible through a browser or other user interface for the decoding device 300 to communicate with the encoding device 400 and/or for the encoding device 400 to communication with the decoder device 300.

In another embodiment, the decoding device 300 and/or the encoding device 400 may include other components or functionalities. As will be recognized, these architectures and descriptions are provided for exemplary purposes only and are not limiting to the various embodiments.

In some embodiments, a file can be modified (e.g., by the encoder device 400) to provide additional information (e.g., one or more context identifiers) associated with capture of related content items that enables more efficient decoding and target picture display by the decoder device 300 or a display device on the decoder-side.

In some embodiments, the encoder device 400 can comprise means, such as at least one processor and at least one memory storing instructions stored thereon that, when executed by the at least one processor, cause the encoder device 400 to generate a first file that comprises a first content item and one or more first context identifiers. In some embodiments, the first content item may correspond to at least a portion of the original video data 101. The first file may be configured with a predefined digital container format for media content. For example, the first file may be a HEIF file, an ISOBMFF file, or another type of container file data structure for the first content item. The first content item may include media content such as video content, audio content, one or more images, a sequence of images, and/or other media content. In some embodiments, a context identifier of the one or more first context identifiers comprises a capture session identifier for a capture session associated with capture of the first content item. In some embodiments, a context identifier of the one or more first context identifiers comprises an event identifier for an event associated with capture of the first content item. In some embodiments, a context identifier of the one or more first context identifiers comprises a presentation identifier for a media presentation associated with capture of the first content item. In some embodiments, a context identifier of the one or more first context identifiers comprises a global session identifier associated with pose information used for capture of the first content item. For example, the pose information may include camera extrinsic matrix information related to capture of the first content item. In some embodiments, the encoder device 400 may insert a session indicator that specifies a type of context identifier for a corresponding context identifier of the first file. In some embodiments, the encoder device 400 may insert the one or more first context identifiers into a Metabox data structure of the first file. For example, the Metabox data structure may be a metadata identifier box for the first file. In some embodiments, the encoder device 400 may insert the one or more first context identifiers into a Moviebox data structure of the first file. For example, the Moviebox data structure may be a movie presentation identifier box for the first file.

In some embodiments, the encoder device 400 can comprise means, such as at least one processor and at least one memory storing instructions stored thereon that, when executed by the at least one processor, cause the encoder device 400 to generate a second file that comprises a second content item and one or more second context identifiers. The second file may be configured with a predefined digital container format for media content. For example, the second file may be a HEIF file, an ISOBMFF file, or another type of container file data structure for the second content item. The second content item may include media content such as video content, audio content, one or more images, a sequence of images, and/or other media content. In some embodiments, a context identifier of the one or more second context identifiers comprises a capture session identifier for a capture session associated with capture of the second content item. In some embodiments, a context identifier of the one or more second context identifiers comprises an event identifier for an event associated with capture of the second content item. In some embodiments, a context identifier of the one or more second context identifiers comprises a presentation identifier for a media presentation associated with capture of the second content item. In some embodiments, a context identifier of the one or more second context identifiers comprises a global session identifier associated with pose information used for capture of the second content item. For example, the pose information may include camera extrinsic matrix information related to capture of the second content item. In some embodiments, the encoder device 400 may insert a session indicator that specifies a type of context identifier for a corresponding context identifier of the second file. In some embodiments, the encoder device 400 may insert the one or more second context identifiers into a Metabox data structure of the second file. For example, the Metabox data structure may be a metadata identifier box for the second file. In some embodiments, the encoder device 400 may insert the one or more second context identifiers into a Moviebox data structure of the second file. For example, the Moviebox data structure may be a movie presentation identifier box for the second file.

In some embodiments, a corresponding context identifier between the one or more first context identifiers and the one or more second context identifiers indicates a particular context associated with capture of the first content item and the second content item. For example, the corresponding context identifier may comprise a capture session identifier for a capture session associated with the capture of the first content item and the second content item. In another example, the corresponding context identifier may comprise an event identifier for an event associated with the capture of the first content item and the second content item. In another example, the corresponding context identifier may comprise a presentation identifier for a media presentation associated with the capture of the first content item and the second content item. In some embodiments, the corresponding context identifier may comprise a global session identifier associated with pose information used for the capture of the first content item and the second content item. In some embodiments, the pose information may be associated with pose of an entity expressed by camera extrinsic matrix information used for capture of the first content item and the second content item. In some embodiments, the entity is a capture device.

In some embodiments, an entity used for capture of a content item (e.g., the first content item and the second content item) may be a camera sensor, an audio microphone, a LiDAR device, or time of flight sensor.

In some embodiments, pose of an entity used for capture of the first content item and pose of an entity used for capture of the second content item are express in the same coordinate space.

In some embodiments, pose of an entity used for capture of a content item (e.g., the first content item and the second content item) may be express by a GPS position together with orientation of the entity.

In some embodiments, the decoder device 300 can comprise means, such as at least one processor and at least one memory storing instructions stored thereon that, when executed by the at least one processor, cause the decoder device 300 to receive the first file that comprises the first content item and the one or more first context identifiers. In some embodiments, the decoder device 300 can comprise means, such as at least one processor and at least one memory storing instructions stored thereon that, when executed by the at least one processor, cause the decoder device 300 to receive the second file that comprises the second content item and the one or more second context identifiers. In some embodiments, the decoder device 300 can comprise means, such as at least one processor and at least one memory storing instructions stored thereon that, when executed by the at least one processor, cause the decoder device 300 to compare the one or more first context identifiers and the one or more second context identifiers to determine a corresponding context identifier that indicates a particular context associated with capture of the first content item and the second content item.

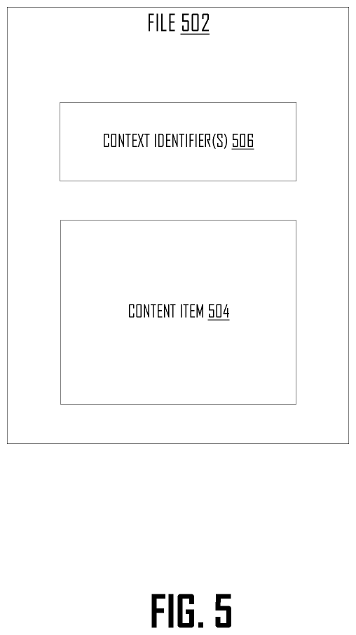

FIG. 5 illustrates an example file 502, according to one or more embodiments. The file 502 may be a HEIF file, an ISOBMFF file, or another type of container file data structure for one or more portions of video data. (e.g., original video data 101, etc.). In some embodiments, a video encoder (e.g., the video encoder 102, the encoding device 400, etc.) may generate and/or transmit the file 502. In some embodiments, a video decoder (e.g., the video encoder 106, the decoding device 300, etc.) may receive and/or process the file 502. The file 502 includes at least content item 504 and one or more context identifiers 506. The content item 502 may include media content such as video content, audio content, one or more images, a sequence of images, and/or other media content.

The one or more context identifiers 506 may indicate a particular context associated with capture of the content item 502. In some embodiments, a context identifier of the one or more context identifiers 506 comprises a capture session identifier for a capture session associated with capture of the content item 502. In some embodiments, a context identifier of the one or more context identifiers 506 comprises an event identifier for an event associated with capture of the content item 502. In some embodiments, a context identifier of the one or more context identifiers 506 comprises a presentation identifier for a media presentation associated with capture of the content item 502. In some embodiments, a context identifier of the one or more context identifiers 506 comprises a global session identifier associated with pose information for capture of the content item 502. For example, the pose information may include camera extrinsic matrix information related to capture of the content item 502. In some embodiments, the encoder device 400 may insert a session indicator that specifies a type of context identifier for a corresponding context identifier of the file 502. In some embodiments, the one or more context identifiers 506 may be included in a Metabox data structure of the file 502. For example, the Metabox data structure may be a metadata identifier box for the file 502 that includes the one or more context identifiers 506. In some embodiments, the one or more context identifiers 506 may be included in a Moviebox data structure of the file 502. For example, the Moviebox data structure may be a movie presentation identifier box for the file 502 that includes the one or more context identifiers 506.

In some embodiments, a context identifier of the one or more context identifiers 506 is a URI.

In some embodiments, a context identifier of the one or more context identifiers 506 is a tag URI which may comply with IETF RFC 4151. For example, a tag URI may include an authority name, a timestamp, and/or a date stamp. Additionally, the tag URI may include additional specification. In some embodiments, an authority name may identify a provider that included the context identifier and/or a timestamp/date stamp when the context identifier was assigned. In some embodiments, a timestamp and/or a date stamp may be utilized to distinguish among different versions of a context identifier that is otherwise the same.

In an embodiment, at least some of the processes described herein may be carried out by an apparatus comprising means for carrying out at least some of the described processes. Means for performing method operations as disclosed herein may include software and/or hardware components (e.g., 110, 120, 220, 230, 320, 330) of the apparatus. For example, at least one processor and at least one memory storing thereon computer program codes can comprise means for carrying out the method or methods as disclosed herein, and any of the embodiments thereof. As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

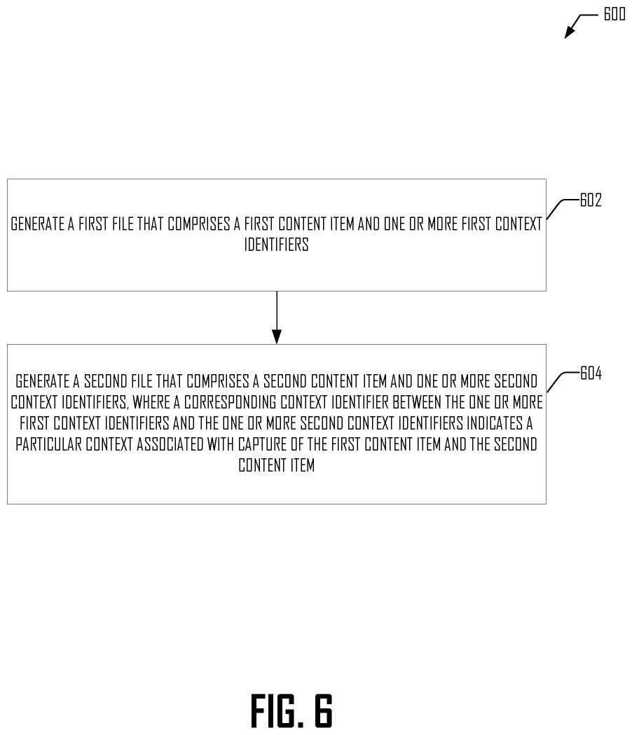

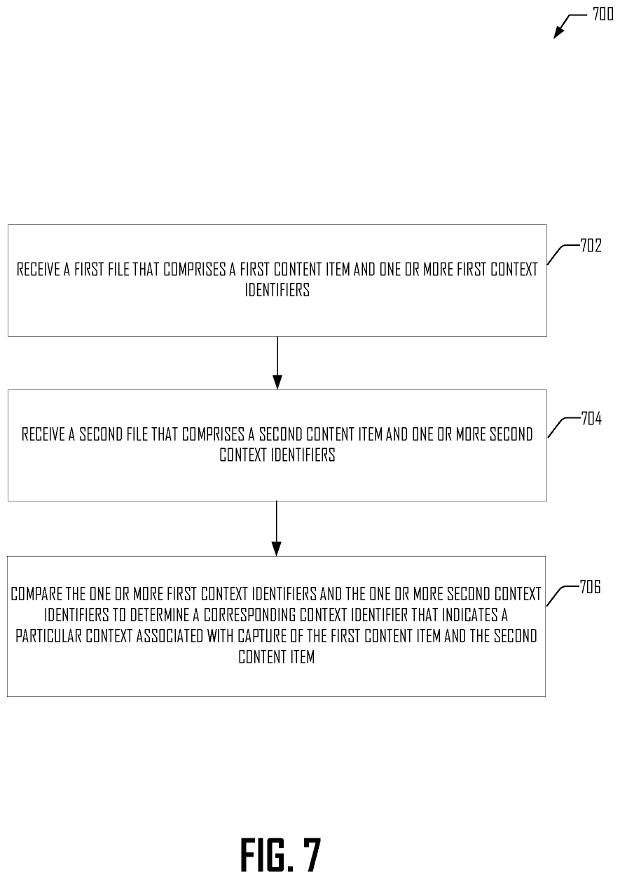

FIG. 6 illustrates a flowchart depicting a method 600 and FIG. 7 illustrates a flowchart depicting a method 700 according to one or more example embodiments of the present disclosure. It will be understood that each block of the flowcharts and combination of blocks in the flowcharts can be implemented by various means, such as hardware, firmware, processor, circuitry, and/or other communication devices associated with execution of software including instructions, for example one or more computer program instructions. For example, one or more of the procedures described above can be embodied by computer program instructions. In some embodiments, the computer program instructions which embody the procedures described above can be stored, for example, by the memory 302 of the decoding device 300 illustrated in FIG. 3 employing an embodiment of the present disclosure and executed by a processor (e.g., the controller 301). In some embodiments, the computer program instructions which embody the procedures described above can be stored, for example, by the memory 402 of the encoding device 400 illustrated in FIG. 4 employing an embodiment of the present disclosure and executed by a processor (e.g., the controller 401). As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Referring now to FIG. 6, the operations performed enable providing media content based on context, in accordance with one or more embodiments of the present disclosure. For example, some or all of the method 600 can be carried out using a system (e.g., 100), by an apparatus, or by a computing device, such as 102, 104, 106, 219, 211, 212, 217, 218, 300, 400, etc. For example, an apparatus can comprise at least one processor and at least one memory storing instructions thereon that, when executed by the at least one processor, cause the apparatus to perform some or all of the method 600. Additionally, a computer program product can be provided that comprises a non-transitory computer readable storage medium storing instructions thereon that, when executed by a processor, cause a machine or apparatus to perform some or all of the method 600. In some embodiments, the method 600 is associated with functionality of the video encoder 102 and/or the encoding device 400.

As shown in block 602 of FIG. 6, an apparatus includes means, such as the controller 401, the memory 402, or the like, configured to generate a first file that comprises a first content item and one or more first context identifiers. As shown in block 604 of FIG. 6, an apparatus additionally or alternatively includes means, such as the controller 401, the memory 402, or the like, configured to generate a second file that comprises a second content item and one or more second context identifiers, where a corresponding context identifier between the one or more first context identifiers and the one or more second context identifiers indicates a particular context associated with capture of the first content item and the second content item.

In some embodiments, the corresponding context identifier comprises a capture session identifier for a capture session associated with the capture of the first content item and the second content item. In some embodiments, the corresponding context identifier comprises an event identifier for an event associated with the capture of the first content item and the second content item. In some embodiments, the corresponding context identifier comprises a presentation identifier for a media presentation associated with the capture of the first content item and the second content item.

In some embodiments, the corresponding context identifier comprises a global session identifier associated with pose information for the capture of the first content item and the second content item. In some embodiments, the first file and the second file comprise a predefined digital container format. In some embodiments, the first file and the second file comprise a session indicator that specifies a type of context identifier for the corresponding context identifier.

In some embodiments, a first Metabox data structure of the first file comprises the one or more first context identifiers and a second Metabox data structure of the second file comprises the one or more second context identifiers. In some embodiments, a first Moviebox data structure of the first file comprises the one or more first context identifiers and a second Moviebox data structure of the second file comprises the one or more second context identifiers.

In some embodiments, a context identifier is a URI.

In some embodiments, a context identifier is a tag URI which may comply with IETF RFC 4151. For example, a tag URI may include an authority name, a timestamp, and/or a date stamp. Additionally, the tag URI may include additional specification. In some embodiments, an authority name may identify a provider that included the context identifier and/or a timestamp/date stamp when the context identifier was assigned. In some embodiments, a timestamp and/or a date stamp may be utilized to distinguish among different versions of a context identifier that is otherwise the same.

Referring now to FIG. 7, the operations performed enable providing media content based on context, in accordance with one or more embodiments of the present disclosure. For example, some or all of the method 700 can be carried out using a system (e.g., 100), by an apparatus, or by a computing device, such as 102, 104, 106, 219, 211, 212, 217, 218, 300, 400, etc. For example, an apparatus can comprise at least one processor and at least one memory storing instructions thereon that, when executed by the at least one processor, cause the apparatus to perform some or all of the method 700. Additionally, a computer program product can be provided that comprises a non-transitory computer readable storage medium storing instructions thereon that, when executed by a processor, cause a machine or apparatus to perform some or all of the method 700. In some embodiments, the method 700 is associated with functionality of the video decoder 106 and/or the decoding device 300.

As shown in block 702 of FIG. 7, an apparatus includes means, such as the controller 301, the memory 302, or the like, configured to receive a first file that comprises a first content item and one or more first context identifiers. As shown in block 704 of FIG. 7, an apparatus additionally or alternatively includes means, such as the controller 301, the memory 302, or the like, configured to receive a second file that comprises a second content item and one or more second context identifiers. As shown in block 706 of FIG. 7, an apparatus additionally or alternatively includes means, such as the controller 301, the memory 302, or the like, configured to compare the one or more first context identifiers and the one or more second context identifiers to determine a corresponding context identifier that indicates a particular context associated with capture of the first content item and the second content item.

In some embodiments, the corresponding context identifier comprises a capture session identifier for a capture session associated with the capture of the first content item and the second content item. In some embodiments, the corresponding context identifier comprises an event identifier for an event associated with the capture of the first content item and the second content item. In some embodiments, the corresponding context identifier comprises a presentation identifier for a media presentation associated with the capture of the first content item and the second content item.

In some embodiments, the corresponding context identifier comprises a global session identifier associated with pose information for the capture of the first content item and the second content item. In some embodiments, the first file and the second file comprise a predefined digital container format. In some embodiments, the first file and the second file comprise a session indicator that specifies a type of context identifier for the corresponding context identifier.

In some embodiments, a first Metabox data structure of the first file comprises the one or more first context identifiers and a second Metabox data structure of the second file comprises the one or more second context identifiers. In some embodiments, a first Moviebox data structure of the first file comprises the one or more first context identifiers and a second Moviebox data structure of the second file comprises the one or more second context identifiers.

In some embodiments, a context identifier is a URI.

In some embodiments, a context identifier is a tag URI which may comply with IETF RFC 4151. For example, a tag URI may include an authority name, a timestamp, and/or a date stamp. Additionally, the tag URI may include additional specification. In some embodiments, an authority name may identify a provider that included the context identifier and/or a timestamp/date stamp when the context identifier was assigned. In some embodiments, a timestamp and/or a date stamp may be utilized to distinguish among different versions of a context identifier that is otherwise the same.

It is also noted herein that although the above describes example embodiments, there are several variations and modifications which may be made to the disclosed solution without departing from the scope of the subject disclosure.

In general, the various example embodiments may be implemented in hardware or special purpose circuits, software, logic or any combination thereof. Some aspects of the subject disclosure may be implemented in hardware, whereas other aspects may be implemented in firmware or software which may be executed by a controller, microprocessor or other computing device, although the subject disclosure is not limited thereto. Although various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program processes, or interconnected logic circuits, blocks and functions, or a combination of program processes and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Moreover, in accordance with the foregoing description, the embodiments described herein reflect possible embodiments of the herein presented solution, which are further combinable between embodiments and/or sets of embodiments. These embodiments do not define the entire scope of the disclosure of this application; nor do these embodiments define or limit the scope of the disclosure.

The above-noted aspects and features may be implemented in systems, apparatuses, methods, articles and non-transitory computer-readable media depending on the desired configuration. The subject disclosure may be implemented in and used with a number of different types of devices, including but not limited to cellular phones, tablet computers, wearable computing devices, portable media players, and any of various other computing devices.

The foregoing description has provided by way of non-limiting examples a full and informative description of the example embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of the subject disclosure as defined in the appended claims. Indeed, there is a further embodiment comprising a combination of one or more embodiments with any of the other embodiments previously discussed.

Even though the disclosure has been described above with reference to an example according to the accompanying drawings, it is clear that the disclosure is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

With regard to the illustrated signal flow diagrams and flowcharts depicting methods provided in the drawings and described above, it will be understood that each block or signal and combination of blocks and signals may be implemented by various means, such as hardware, firmware, processor, circuitry, and/or other communication devices associated with execution of software including one or more computer program instructions.

For example, one or more of the procedures described above may be embodied by computer program instructions. In this regard, the computer program instructions which embody the procedures described above may be stored by a memory of the apparatus employing an example embodiment and executed by processing circuitry, such as a processor. As will be appreciated, any such computer program instructions, such as instructions, may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising:
at least one processor; and
at least one memory storing instructions that, when executed by the at least one processor, cause the apparatus to:
generate a first file that comprises a first content item and one or more first context identifiers; and
generate a second file that comprises a second content item and one or more second context identifiers,
wherein a corresponding context identifier between the one or more first context identifiers and the one or more second context identifiers indicates a particular context associated with capture of the first content item and the second content item.

2. The apparatus of claim 1, wherein the corresponding context identifier comprises a capture session identifier for a capture session associated with the capture of the first content item and the second content item.

3. The apparatus of claim 1, wherein the corresponding context identifier comprises an event identifier for an event associated with the capture of the first content item and the second content item.

4. The apparatus of claim 1, wherein the first file and the second file comprise a predefined digital container format.

5. The apparatus of claim 1, wherein the first file and the second file comprise a session indicator that specifies a type of context identifier for the corresponding context identifier.

6. The apparatus of claim 1, wherein a first Metabox data structure of the first file comprises the one or more first context identifiers and a second Metabox data structure of the second file comprises the one or more second context identifiers.

7. The apparatus of claim 1, wherein a first Moviebox data structure of the first file comprises the one or more first context identifiers and a second Moviebox data structure of the second file comprises the one or more second context identifiers.

8. An apparatus comprising:
at least one processor; and
at least one memory storing instructions that, when executed by the at least one processor, cause the apparatus to:
receive a first file that comprises a first content item and one or more first context identifiers;
receive a second file that comprises a second content item and one or more second context identifiers; and
compare the one or more first context identifiers and the one or more second context identifiers to determine a corresponding context identifier that indicates a particular context associated with capture of the first content item and the second content item.

9. The apparatus of claim 8, wherein the corresponding context identifier comprises a capture session identifier for a capture session associated with the capture of the first content item and the second content item.

10. The apparatus of claim 8, wherein the corresponding context identifier comprises an event identifier for an event associated with the capture of the first content item and the second content item.

11. The apparatus of claim 8, wherein the first file and the second file comprise a predefined digital container format.

12. The apparatus of claim 8, wherein the first file and the second file comprise a session indicator that specifies a type of context identifier for the corresponding context identifier.

13. The apparatus of claim 8, wherein a first Metabox data structure of the first file comprises the one or more first context identifiers and a second Metabox data structure of the second file comprises the one or more second context identifiers.

14. The apparatus of claim 8, wherein a first Moviebox data structure of the first file comprises the one or more first context identifiers and a second Moviebox data structure of the second file comprises the one or more second context identifiers.

15. A method comprising:
generating a first file that comprises a first content item and one or more first context identifiers; and
generating a second file that comprises a second content item and one or more second context identifiers,
wherein a corresponding context identifier between the one or more first context identifiers and the one or more second context identifiers indicates a particular context associated with capture of the first content item and the second content item.

16. The method of claim 15, wherein the corresponding context identifier comprises a capture session identifier for a capture session associated with the capture of the first content item and the second content item.

17. The method of claim 15, wherein the corresponding context identifier comprises an event identifier for an event associated with the capture of the first content item and the second content item.

18. The method of claim 15, wherein the first file and the second file comprise a predefined digital container format.

19. The method of claim 15, wherein the first file and the second file comprise a session indicator that specifies a type of context identifier for the corresponding context identifier.

20. The method of claim 15, wherein:
a first Metabox data structure of the first file comprises the one or more first context identifiers and a second Metabox data structure of the second file comprises the one or more second context identifiers, or
a first Moviebox data structure of the first file comprises the one or more first context identifiers and a second Moviebox data structure of the second file comprises the one or more second context identifiers.
